(19) United States
(12) Patent Application Publication
(10) Pub. No.: US 2012/0298645 A1
(43) Pub. Date: Nov. 29, 2012

(54) METHOD AND ASSEMBLY FOR THE ELECTRICALLY CONDUCTIVE CONNECTION OF WIRES

(75) Inventors: Björn Kleespiess, Schoffengrund (DE); Andreas Moos, Heuchelheim (DE); Dieter Stroh, Wettenberg (DE); Udo Wagenbach, Buseck (DE); Peter Wagner, Wettenberg (DE); Alexander Ziesler, Niedernberg (DE)

(73) Assignee: SCHUNK SONOSYSTEMS GMBH, Wettenberg (DE)

(21) Appl. No.: 13/518,967

(22) PCT Filed: Nov. 26, 2010
(86) PCT No.: PCT/EP2010/068278

§ 371 Date: Jul. 20, 2012

(30) Foreign Application Priority Data
Dec. 23, 2009 (DE) 1 02009 059 307.1

(51) Int. Cl. B23K 31/02; B23K 33/00; B23K 20/10

(52) U.S. Cl. 219/137 R; 228/111; 228/1.1

(57) ABSTRACT

A method and assembly for the electrically conductive connection of a bundle of wires having an insulation, wherein the insulation is at least partially removed by means of ultrasonic effects. In order to ensure high mechanical strength in a good electrically conductive connection, according to the invention the insulation of the wires is removed in a first step by means of plastic-ultrasonic welding and the wires are bonded in a second step by means of metal-ultrasonic welding or resistance welding.

The invention relates to a method for electrically-conducting bonding of a bundle of wires with insulation, especially an insulating paint, with the insulation at least partially removed by means of ultrasonic action and if necessary prior to the ultrasonic action, the bundle being assimilated by a sheathing of metallic material. The invention also makes reference to an arrangement for firm bonding of a bundle of insulated wires, especially wires provided with an insulating paint, by means of ultrasound, wherein the bundle can be situated in a compression space of an ultrasonic welding device, which is limited by the oppositely placed sides of a sonotrode generating ultrasonic oscillations and an anvil and laterally by side jaws adjustable if necessary.

To firmly bond materials, ultrasonic welding can be used. For that, the energy required for welding can be inputted into the welded material in the form of mechanical oscillations. For this, ultrasonic oscillations are induced in a sonotrode in their longitudinal direction. At the same time a counterelectrode—also called an anvil—makes a motion relative to the sonotrode, to apply a required static welding force. The materials to be fit together are placed between the counterelectrode and the sonotrode.

With ultrasonic welding, a differentiation is made between plastic ultrasonic welding and metallic ultrasonic welding. When plastic is welded, it is heated in the weld zone by absorption of mechanical oscillations, through reflection of the oscillations in the weld zone and through boundary surface friction in the seam surface. The oscillations are applied vertically, i.e. the longitudinal axis of the sonotrode runs perpendicular to the plane set by the counterelectrode, on which the pair to be joined are placed. Typical frequencies in plastic ultrasonic welding are between 20 kHz and 70 kHz.

In contrast to plastic welding, with metallic ultrasonic welding, the mechanical oscillations are applied parallel to the plane set before the anvil. A complex relation results between the static force acting between the sonotrode and counterelectrode, the oscillating shear forces and a rise in temperature in the joining zone. Typical frequencies with metallic ultrasonic welding are between 20 kHz and 40 kHz, with the operational frequency usually in the area of 20 kHz.

Both with plastic ultrasonic welding and with metallic ultrasonic welding, the joining zone is in the amplitude maximum.

From DE-B-102 29 565, a method can be gleaned for electrically-conducting bonding of painted wires. In the areas where they are to be bonded, the wires to be painted are surrounded at least in sectors by an electrically-conducting material, so that then through ultrasonic action the wires can be firmly bonded with the material with simultaneous breakup of the insulating paint.

So as not to need to insulate painted wires before welding, according to DE-A-196 36 217 they are brought into a receiving space of an ultrasonic welding device limited by a sonotrode and an anvil, with the sonotrode and/or anvil having a profile.

According to JP-A-22075481, wires having insulation are surrounded by a sheathing consisting of electrically-conducting material, which then can be bonded with the wires in an ultrasonic welding device. The sonotrode has a W-shaped geometry in cross section and the sonotrode has a convex pattern in relation to the anvil.

From JP-A-4370669, a method can be gleaned for bonding electrically-conducting wires with a cable shoe. For insulation removal, ultrasound impinges on the wires. At the same time, crimping lugs are bent back to secure the wires in the cable shoe.

To bond electrical wires surrounded by insulation with a connection, the former are situated next to each other, to thus attain a firmly bonded connection by means of ultrasound U.S. Pat. No. 6,009,366).

To bond wires surrounded by insulation with an attachment, U.S. Pat. No. 4,317,277 makes provision for a metallic element that has projections penetrating the insulation and surrounds the wires.

For one thing the present invention has the task of further developing a method and an arrangement of the type mentioned initially so that a secure firmly bonded connection is possible between insulated wires, especially wires equipped with insulated paint. At the same time, compared to known methods, it is simplified. High-level mechanical strength is ensured accompanied by good electrical connection of the bonding.

For another thing, the task of the invention is to also bond bare wires or strands which in and of themselves lead to problems in welding, to the required extent.

For solution to the problem, the invention in essence makes provision that either in a first step plastic ultrasonic welding is used to at least partially remove the insulation of the wires and in a second step the wires are firmly bonded by means of metallic ultrasonic welding or resistance welding, or that prior to metallic sheathing the bundle of wires like the sleeve is accommodated by the metallic sheathing, and the metallic sheathing with its longitudinal axis is placed transverse to the longitudinal axis of a sonotrode transmitting ultrasonic oscillations, and by means of the ultrasonic welding, the insulation is partially removed and the wires are firmly bonded with each other and with the metallic sheathing. At the same time a recess like a trough-like notching is shaped transverse to the longitudinal axis of the sleeve-like metallic sheathing. If the insulation is removed preferably in a procedural step that precedes the sheathing, then, surprisingly, the insulation can be at least partially removed during welding in the sheathing.

Wires appropriately provided with insulating paint usually have a diameter of at least 0.3 mm, preferably with the diameter range between 0.4 mm and 1.5 mm, without the invention-specific teaching being thereby restricted. The wires are solid copper or aluminum wires made of copper or aluminum alloys. It is also possible to mix the materials, thus wires of materials that vary from each other. To attain a sufficient stiffness, additionally at least one steel wire is contained in the bundle of wires, without reducing the service life of the sonotrode; because the metallic sheathing—as a shaped sheet piece—prevents direct contact between the sonotrode and the wires.

Advantages also especially accrue with welding of aluminum wires, even those of large cross section; because the sheath offers protection against adhering or alloying on.

Tin-plated wires can also be welded with no problems.

Peeling of the strands of the wires is avoided due to the sleeve.

A bundle of wires with varying cross sections can be welded ultrasonically with no problems. The damping otherwise to be found in welding of wires having differing cross sections due to the metal sheathing does not occur.

According to the invention, preferably a two-stage method is used, by means of which first the insulation, i.e. the insulating paint, is broken and dislodged, so then the wires that have been stripped of insulation in sectors are firmly bonded with each other. This preferably is done by ultrasound, even if a welding of the wires at least partially stripped of insulation is also possible by means of resistance welding.

If the stripping off of the insulation and the firm bonding are not to be done in two procedural steps but rather in a single procedural step, an alternative proposal of the invention makes provision that the bundle of wires be incorporated into a sleeve or appropriate sheathing, and that it be directed in reference to the sonotrode transmitting the ultrasonic oscillations to an ultrasonic welding device so that the longitudinal axis of the sleeve or sheathing runs transverse to the longitudinal direction of the ultrasonic oscillations, thus transverse to the longitudinal axis of the sonotrode. Surprisingly, with an arrangement in this regard it has been shown that the insulating paint can also be broken up to the required extent and removed, to then make possible a firm bonding. At the same time the sleeve or sheathing is reshaped which experiences a notch-like recessing transverse to the longitudinal direction through the force acting via the sonotrode during ultrasonic welding, through which additionally the bond between the sleeve and the wires stripped of insulation is strengthened.

The longitudinal axis of the sleeve or sheathing—designated basically hereinafter for the sake of simplicity as the sleeve—runs in the direction of the wires, thus in the longitudinal direction of the bundle of wires to be welded.

Preferably with a two-stage procedure, provision is made that after the plastic ultrasonic welding, the wires are surrounded by a sleeve and then firmly bonded with the sleeve. With this, the longitudinal axis of the sheath can be oriented with the wires in the longitudinal direction of the ultrasonic oscillations, if the ultrasound is applied during metallic ultrasonic welding.

True, it is not compulsory for the wires compacted through plastic ultrasonic welding into a knot to be brought into a sleeve.

If a sleeve is used, then additionally a possibility exists to arrange its longitudinal axis transverse to the ultrasonic oscillations, so that in this case there arises a notching, as has been previously explained.

Especially good welding results can be obtained if, during plastic welding, the wires are compacted into a first cuboid form with a height Hi in the longitudinal direction of the ultrasonic oscillations and a width B1 transverse to the longitudinal direction, and then during metallic ultrasonic welding, the wires are reshaped into a second cuboid form with a height H2 with H2<H1 and a width B2 with B2>B1.

Additionally, during the metallic ultrasonic welding, the wires can be fully bonded with a carrier. In this case often it is not required that the wires previously stripped of insulation be surrounded by a sleeve.

Upon the wires being fed into a compression space of an ultrasonic welding device, to preclude the wires from being spread out in such a way that it is not possible to insert them without problems, in a further development of the invention, provision is made that at least during feeding for plastic ultrasonic welding, the wires are assimilated by a fixing aid or be surrounded by one such. A fixing sleeve can be used as the fixing aid. Also a tool can be used that solely surrounds the bundle of wires during feeding to the compression space.

The insulation can be at least partially removed, especially the paint broken up, in a first processing station, with the firm bonding in contrast taking place in a second one.

In the emphasized embodiment of the invention, provision is however made that the plastic ultrasonic welding and the metallic ultrasonic welding are carried out at the same processing station, where with plastic ultrasonic welding, the sonotrode for metallic ultrasonic welding is the anvil for plastic ultrasonic welding, and with metallic ultrasonic welding the sonotrode for plastic ultrasonic welding is the anvil for metallic ultrasonic welding.

When the insulating paint is broken up during ultrasonic action, the insulating paint is partially vaporized and charred. To prevent the firm bonding to be impaired thereby during metallic ultrasonic welding, the invention makes provision that in the area of the wire ends, the bundle of wires is impinged on during plastic ultrasonic welding, with the bundle being compacted into a cuboid form, then after plastic ultrasonic welding to undergo cut-like separation of the free end of the compacted bundle. By this means, paint residues present between the wires are additionally removed.

The invention also is characterized by a method for electrically conducting bonding of a bundle of bare strands or wires by ultrasonic action, with the bundle being assimilated prior to ultrasonic action by a metallic sheathing like a sleeve of metallic material, in that the bundle is assimilated by the metallic sheathing and the metallic sheathing is arranged with its longitudinal axis transverse to the longitudinal axis of a sonotrode transmitting ultrasonic oscillations, and by means of ultrasonic welding, the strands or wires are firmly bonded to each other and equipped with the metallic sheathing wherein simultaneously, transverse to the longitudinal axis of the metallic sheathing, a recess is shaped into it. With a suitable method, the features explained previously can correspondingly be claimed.

Additionally, an arrangement for firm bonding of a bundle of insulated wires, especially of wires equipped with insulating paint, by means of ultrasound, with the bundle able to be arranged in a compression space of an ultrasonic welding device, which is limited on the opposite sides of a sonotrode generating ultrasonic oscillations and an anvil, and laterally if necessary by adjustable side jaws, is characterized in that the arrangement has a first and a second sonotrode, whose longitudinal axes intersect at a right angle, that the arrangement is suitable both for metallic ultrasonic welding and for plastic ultrasonic welding, and that with the metallic ultrasonic welding, the second sonotrode is unexcited and the anvil for the first sonotrode and the first sonotrode is excitable, and with plastic ultrasonic welding the first sonotrode is unexcited and the anvil for the second sonotrode and the second sonotrode is excitable.

Additional particulars, advantages and features of the invention come not only from the claims, and the features to be gleaned from them—as such and/or in combination—but also from the following specification of the preferred embodiment examples to be gleaned from the drawings.

Shown are:

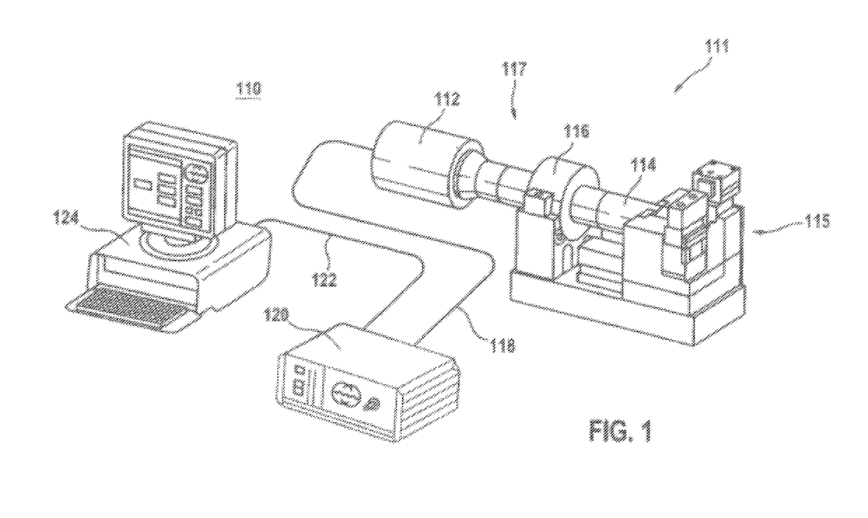

FIG. 1 A general depiction of an ultrasonic welding device

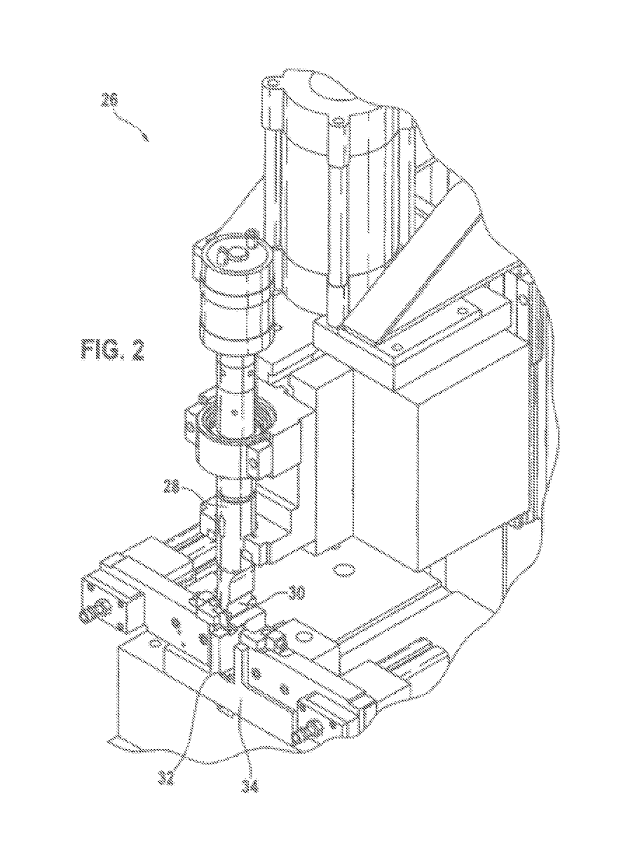

FIG. 2 a cross section of a plastic ultrasonic welding device

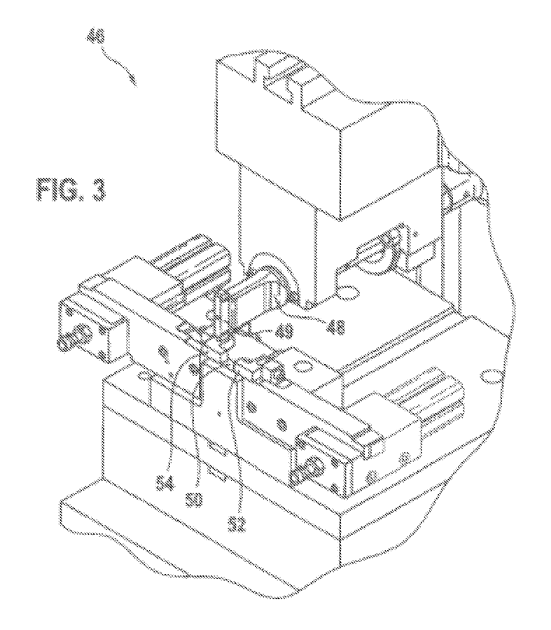

FIG. 3 a cross section of a metallic ultrasonic welding device

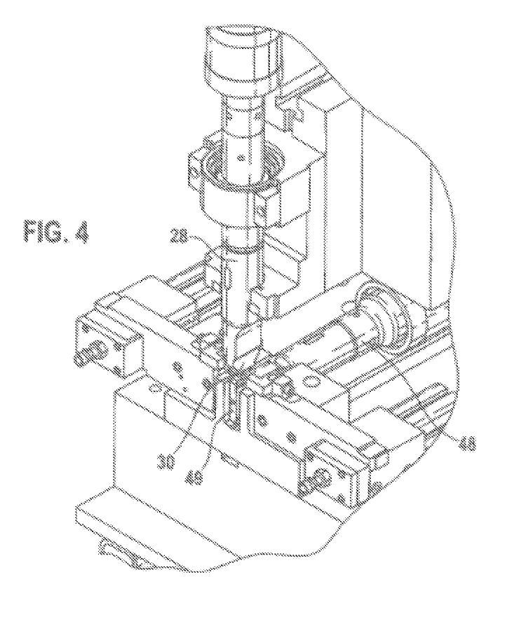

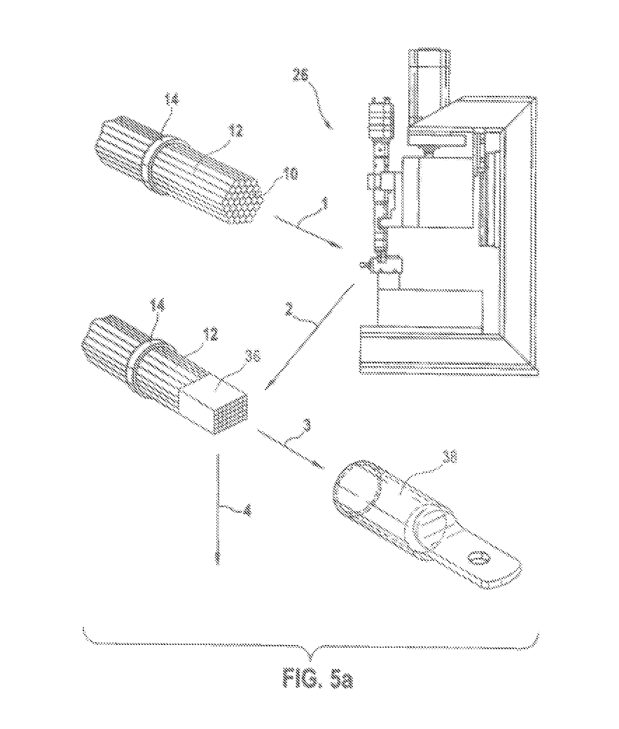

FIG. 4 a cross section of a plastic-metallic ultrasonic welding device

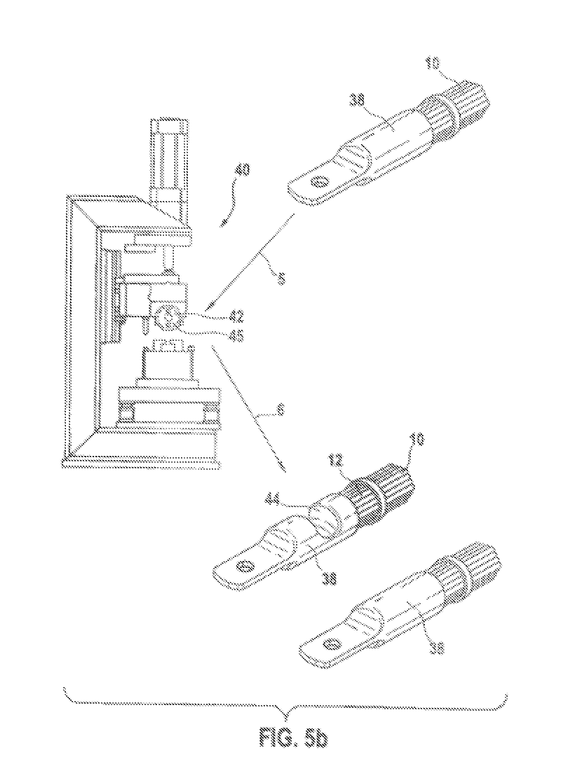

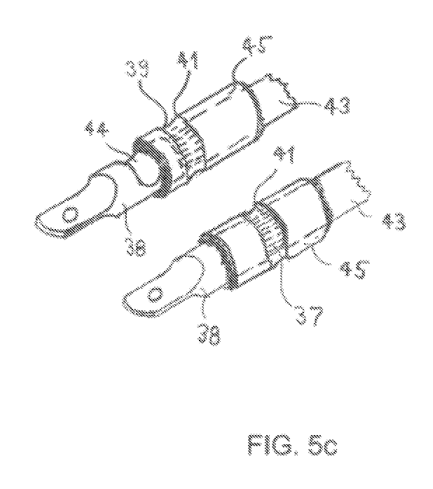

FIGS. 5a, 5b an invention-specific procedural sequence

FIG. 5c a variant of FIGS. 5a and 5b

In the figures, in which generally the same reference symbols are used for the same elements, preferred embodiment examples or cases of application are depicted of an invention-specific method for firm bonding of wires provided with insulation, wherein the wires 10 preferably are painted wires. The wires to be welded are first combined into a bundle. To prevent spreading out, the bundle 12 can be surrounded by a fixing aid in the form of a ring 14 or sleeve, as is evident generally from the figures.

To impart compactness to the bundle 12 of insulated wires 10, which can have diameters between 0.3 mm and 1.5 mm, and thus are sufficiently rigid, and to bond them in electrically-conducting fashion, plastic ultrasonic welding is used in combination with metallic ultrasonic welding, with the latter able to be replaced by resistance welding if necessary.

FIG. 1 generally shows an ultrasonic welding device, to explain the essential elements. The arrangement 110 is explained using an ultrasonic welding device 111, that is meant for welding of metals.

As essential elements, ultrasonic welding device 110 comprises a converter 112 and a sonotrode 114, between which a booster 116 is placed for amplitude gain. Converter 112, booster 116 and sonotrode 114 form a so-called ultrasonic oscillator 117, which is supported in booster 116. To sonotrode 114, i.e. its head not visible in FIG. 1, a counterelectrode 115 is assigned, to which the oscillator 117 can be lowered, to impart forces during welding on the pair for joining. Additionally, lateral sliders are present, to allow adjustment of the sonotrode 114, counterelectrode or anvil 115 and the compression space surrounding the lateral sliders to the desired extent in height and width. Especially the counterelectrode 115 is configured in multiple parts, as is described in U.S. Pat. No. 4,596,352.

The converter 112 is connected by a line 118 with a generator 120, which for its part is attached via a line 122 to a computer 124. Via the generator 120 the converter 112, i.e. the piezocrystal disks placed in it are impinged on by high-frequency voltage, to correspondingly expand and contract the disks, through which ultrasonic oscillations are generated with an amplitude that, increased by booster 116, are transferred to sonotrode 114.

According to the invention, the painted insulation of the wires 10 combined into a bundle 12 are broken up by ultrasound and expelled. With application of ultrasound and force, the rigid wires 10 supply the resistance necessary so that the paint can be removed. At the same time compaction occurs. This is done in a plastic ultrasonic welding device 26, as can be seen generally in FIG. 2.

If the wires 10 should not have enough rigidity, a steel wire can be inserted into the bundle, through which the desired or required stiffness is attainable, to allow the insulation or paint to be removed or broken up upon application of ultrasound.

A steel wire of this nature does not cause the sonotrode to become subject to increased wear, as long as, prior to welding, the bundle—as explained below—is assimilated by a metallic sheathing or sleeve, which is welded with the bundle.

One essential component part of the corresponding device 26 is a sonotrode 28, which is supported in vibrational nodes. The sonotrode 28, which in the embodiment example is a λ/2 oscillator, has a sonotrode head 30 with a front surface that runs parallel to the bracing surface 32 of a counterelectrode 34, on which the bundle 12 is positioned. The sonotrode 28 is set into oscillation in the direction of its longitudinal axis, so that through the arrangement of the sonotrode 28 and its weld surface formed by the front surface of sonotrode head 30 to the bracing surface 32 of anvil 34 likewise serving as a weld surface, the ultrasonic oscillations can be applied perpendicular into the wires 10 of bundle 12, if a corresponding bundle 12 is placed on the weld surface 32 of anvil 34. Consequently the longitudinal axis of the wires 10 or of the bundle 12 within the compression space runs perpendicular to the longitudinal axis of sonotrode 28. For starting the ultrasonic oscillations, sonotrode 28 is appropriately lowered in the direction of a bundle 12 not shown. The compression space limited on the one side by the front surface of sonotrode head 30 and on the other side by weld surface 32 of anvil 34 can be closed laterally by sliders that are not designated with any greater precision, to make it possible to adjust the width.

The appropriate procedural step can also be gleaned from FIG. 5a and is designated by 1. The bundle 12 of wires 10, which is surrounded by fixing sleeve 14, is placed in an appropriate compression space of an ultrasonic welding device which matches that of FIG. 2. By application of ultrasound, the paint is broken up and expelled while the bundle 12 is simultaneously compacted within the compression and welding space, so that corresponding to the circumferential geometry of the compression space, a cuboid geometry is produced on the compacted end area 36 of bundle 12.

As was mentioned, due to ultrasonic action, simultaneously the insulating paint of the wires 10 is broken up and expelled. Partial damping also occurs. Since too much burned paint could be present in the end area, which hinders the following procedural steps, the free end of the reshaped cuboid-shaped end area 36 should be severed.

After the bundle 12 subjected to plastic ultrasonic welding is removed from the compression space (step 2 in FIG. 5a), in the embodiment example an attachment sleeve or a so-called annular cable shoe 38 is slid onto the cuboid-shaped end section 36 of the bundle 12 (procedural step 3). The unit relating to this is then placed in a compression space of a metallic ultrasonic welding device 40, to undertake firm bonding between the annual cable shoe 30 or another element like a sleeve or sheet and the wire bundle 12 that has been freed of the paint beforehand at least in part. With this there exists a possibility to place the attachment eye into the compression space of the metallic ultrasonic welding device 40 in the longitudinal direction of sonotrode 42 (perpendicular to the plane of the drawing) or—as is evident generally in FIG. 5b—transverse to it, and thus in the direction of arrow 5. In this case the longitudinal axis of the annular cable shoe 38 extends perpendicular to the longitudinal axis of the sonotrode, with the result that when force is applied and ultrasound transmitted to accord with the geometry of the sonotrode in the oscillation peak, in which the sonotrode acts on annular cable shoe 38, a notching 44 is formed (see the removal section 6 in FIG. 5b). By this means, a locking of shape and force is strengthened between annular cable shoe 38 and bundle 12.

Instead of annular cable shoe 38, the bundle 12 can also be assimilated by a metallic sheathing of suitable geometry.

In the embodiment example of FIG. 5, as the sonotrode 42 a λ-sonotrode is used, which is supported at one end and acts on annular cable shoe 38 at a distance λ/2 from the front end 44.

If annular cable shoe 38 is positioned parallel to the longitudinal axis of a sonotrode with metallic ultrasonic welding, then the annular cable shoe 38 is reshaped in the longitudinal direction, as should be made clear by the lower right depiction in FIG. 5b generally.

In other words, in the lower left figure in 5b, the wires 10 that have been firmly bonded with annular cable shoe 38 and previously partially stripped of insulation are placed transverse to the sonotrode longitudinal axis when annular cable shoe 38 is oriented, and in the lower left figure, they are parallel to the sonotrode longitudinal axis in the compression space that is not designated in any greater detail.

The measures and procedural steps that have been explained in connection with FIGS. 4 and 5 for firm bonding of insulated wires with each other and with the annular cable shoe, correspondingly hold true for firm bonding of bare strands and wires with each other and with a corresponding annular cable shoe 38 or another metallic sheathing with suitable geometry, in which, after ultrasonic welding, a notching, which matches that of notching 44 as per FIG. 5b, is made into that is transverse to the sheathing or its longitudinal direction.

FIG. 3 depicts a section of an ultrasonic welding device 46 by which wires 10 that have in sectors been stripped of insulation are firmly bonded with each other. In the embodiment example, the wires 10 are aligned parallel to the longitudinal axis of a sonotrode 48. It is not necessary after the insulation is stripped off that the wires 10 be accommodated by a sleeve. Rather, the wires 10 can be welded for example with a sheet that is positioned on an anvil 50 of the ultrasonic welding device 46. Additionally recognized are the lateral sliders 52, 54 that provide lateral limits to the compression space.

A possibility also exists that the bundle 12 of wires 10 that is initially partially stripped of insulation is compressed into a knot and welded, without being joined with another metallic element.

In accordance with the invention-specific teaching, the wires 10 can be stripped of insulation in a first processing station—like that of FIG. 2—and further compaction and firm bonding with each other, and for example with a carrier or a sleeve can occur in a second processing station as per FIG. 3.

From the embodiment example of FIG. 4 a further alternative emerges, according to which both the at least partial stripping of insulation of the wires 10 and their firm bonding are done in a single operations station. For this, it has two sonotrodes 28, 48 according to FIGS. 2 and 3. The sonotrodes 28, 48 are directed with their heads 30, 49 toward each other so that they perform a double function, namely serving to transmit the required ultrasonic oscillations and to perform the function of an anvil.

If the wires 10 are to be stripped of insulation as per FIG. 4 in the compression space limited by sonotrode heads 30, 49, then sonotrode head 49 of sonotrode 48 serves as the anvil. Then sonotrode 28 emits the ultrasonic oscillations to break up the paint or insulation. Consequently a plastic welding process is carried out.

If then the bundle 12 of wires 10 are to be firmly bonding or if necessary a sleeve slid on them, then sonotrode head 30 of sonotrode 28 serves as the counterelectrode or anvil, while sonotrode 48 is excited in ultrasonic oscillations and transmits them to the materials to be fitted together. A metallic welding process occurs.

If first the wires 10 have insulation stripped from them and then are welded with the sleeve like an annular cable shoe 38 or some other sheathing such as a shaped sheet, then customarily the wires 10 are stripped of insulation outside the sleeve over a section of several millimeters. This area 37 is limited by two annular boundaries—on one side the opening 39 of sleeve 38 and on the other side the edge 43 of the insulation of the wires 10. This area 37 can be surrounded with no problems by a shrinkdown tube 45 for insulation of the wires 10 (FIG. 5c).

It is to be noted regarding the wires 10 to be welded, that they do not have to consist of the same material and also do not have to have the same cross section.

Rather, a materials mixture can be welded. Also, wires 10 of differing cross section can be welded.

The invention-specific teachings also apply for bare strands or wires that are firmly bonded in and with a sheathing.

Welding of bare strands or wires in the metallic sheathing is consequently likewise covered by the invention-specific teaching, with the sheathing placed during welding with its longitudinal axis transverse to the longitudinal axis of a sonotrode, to shape a recess in it transverse to the longitudinal axis of the sheathing.

If the invention-specific teaching has been explained in the embodiment examples using wires that have insulating paint, thus a hard insulation, then application is also possible for other wires provided with a soft insulation.

1. Method for electrically conducting bonding of a bundle (12) of wires (10) provided with insulation, especially an insulating paint, wherein the insulation is at least partially removed by ultrasonic treatment and wherein if necessary before the ultrasonic treatment the bundle is assimilated by a metallic sheathing (38) like a sleeve of metallic material,
characterized in that
the bundle (12) of wires (10) is assimilated by the metallic sheathing (38) and the metallic sheathing is situated with its longitudinal axis transverse to the longitudinal axis of a sonotrode (42) transmitting ultrasonic oscillations and the wires are joined with each other and with the metallic sheathing in firm bonding by ultrasonic welding, wherein simultaneously, transverse to the longitudinal axis of the metallic sheathing, into it a recess (44) is shaped, wherein the insulation is at least partially removed either during the ultrasonic welding with the bundle assimilated by the metallic sheathing, or before insertion into the metallic sheathing in a previous procedural step by means of plastic ultrasonic welding, or
that in a first step the insulation of the wires is at least partially removed by means of plastic ultrasonic welding, and in a second step the wires are firmly bonded by means of metallic ultrasonic welding or resistance welding.

2. Method according to claim 1,
characterized in that
wires (10) equipped with an insulating paint are firmly bonded, with the wires having a diameter D with D≧0.3 mm, especially 0.4 mm≧D≧1.5 mm.

3. Method according to claim 1, characterized in that
after the plastic ultrasonic welding the wires (10) are surrounded by the metallic sheathing (38) and then firmly bonded with the metallic sheathing.

4. Method according to claim 1,
characterized in that
the wires (10) that are surrounded by a metallic sheathing (38) during metallic ultrasonic welding, are situated in the longitudinal direction of the ultrasonic oscillations.

5. Method according to claim 1,
characterized in that
the metallic sheathing (38) with the wires are situated transverse to the direction of ultrasonic oscillations during ultrasonic welding.

6. Method according to claim 1
characterized in that
in the area of the wire ends, the bundle (12) is irradiated with ultrasound during the plastic ultrasonic welding, that during the plastic ultrasonic welding the bundle is compacted into a cuboid form (36) and that after the plastic ultrasonic welding the free end of the compacted bundle is cut off.

7. Method according to claim 1,
characterized in that
during the plastic ultrasonic welding the wires (10) are compacted into a first cuboid form with a height H1 in the longitudinal direction of the ultrasonic oscillations and a width B1 transverse to the longitudinal direction, and that during the metallic ultrasonic welding, the wires are reshaped into a second cuboid form with a height H2 with H2<H1 and a width B2 with B2>B1.

8. Method according to claim 1,
characterized in that
the bundle (12) of wires (10) is surrounded by a metallic sheathing (38), which is placed between the sonotrode and anvil of an ultrasonic welding device during the plastic ultrasonic welding.

9. Method according to claim 1,
characterized in that
the wires (10) are firmly bonded with a carrier during the metallic ultrasonic welding.

10. Method according to claim 1,
characterized in that
at least during being fed for plastic ultrasonic welding, the wires (10) are assimilated by a fixing aid (14) or surrounded by one such.

11. Method according to claim 1,
characterized in that
a fixing sleeve or a fixing ring (14) is used as the fixing aid.

12. Method according to claim 1,
characterized in that
the plastic ultrasonic welding is conducted in a first processing station (26) and the metallic ultrasonic welding in a second processing station (40).

13. Method according to claim 1, wherein both with the plastic ultrasonic welding and with the metallic ultrasonic welding, the bundle (12) of wires (10) is situated between an anvil and a sonotrode (28, 40) emitting ultrasound,
characterized in that
the plastic ultrasonic welding and the metallic ultrasonic welding are carried out in the same processing station, wherein with plastic ultrasonic welding the sonotrode (48) is the anvil for the metallic ultrasonic welding, and with metallic ultrasonic welding the sonotrode (28) is the anvil for the plastic ultrasonic welding.

14. Method according to claim 1,
characterized in that
an insulated area running between the metallic sheathing (38) and insulation of the wires (10) that form the bundle (12) is surrounded by an insulation like shrinkdown tubing (45).

15. Method for electrically conducting connection of a bundle (12) of exposed strands or wires (12) by means of ultrasonic treatment, wherein prior to the ultrasonic treatment, the bundle is assimilated by a metallic sheathing (38) like a sleeve of metallic material,
characterized in that
the sheathing (38) with the bundle (12) assimilated in sections is situated with its longitudinal axis transverse to the longitudinal axis of a sonotrode (42) transmitting ultrasonic oscillation and that the wires (10) or strands are firmly bonded to each other and with the metallic sheathing by means of ultrasonic welding, with a recess being shaped simultaneously into it transverse to the longitudinal axis of the metallic sheathing.

16. Arrangement for firm bonding of a bundle (12) of insulated wires (10), especially of wires provided with an insulating paint, by means of ultrasound, with the bundle able to be placed in the compression space of an ultrasonic welding device (26), which is limited by the oppositely placed sides of a sonotrode (28, 48) generating ultrasonic oscillations and an anvil (34, 50) and laterally by adjustable side jaws,
characterized in that
the arrangement has a first and second sonotrode (28, 48) the longitudinal axes of which intersect at a right angle, that the arrangement is suitable both for metallic ultrasonic welding and for plastic ultrasonic welding, and that with metallic ultrasonic welding, the second sonotrode (28) is unexcited and the anvil for the first sonotrode (48) and the first sonotrode is excitable and with plastic ultrasonic welding the first sonotrode is unexcited and the anvil for the second sonotrode and the second sonotrode is excitable.
